(19) United States
(12) Patent Application Publication
(10) Pub. No.: US 2002/0140232 A1
(43) Pub. Date: Oct. 3, 2002

(54) Device for axially conneting two pipe-like components

(75) Inventors: Robert Bohrer, Bruchkobel (DE); Michael Hauke, Wachtersbach (DE); Dietrich Knuth, Hanau (DE); Stephan Mann, Biebergemund (DE)

Correspondence Address: Friedrich Kueffner, 317 Madison Avenue, Suite 910, New York, NY, 10017, US

(73) Assignee: Rasmussen GmbH

(21) Appl. No.: 10/101,115

(22) Filed: Mar. 19, 2002

(30) Foreign Application Priority Data
Apr. 3, 2001 (DE) 101 16 591.9

(51) Int. Cl. F16L 17/00

(52) U.S. Cl. 285/369; 285/373

(57) ABSTRACT

An axial connector for axially connecting two pipe-shaped components, wherein the two pipe-shaped components have end portions with radial flanges, has a tightenable connecting device engaging the two flanges positive-lockingly and loading the two flanges in a direction toward one another. A thermally highly loadable sealing device is arranged between the flanges. The connecting device has at least one sheet metal strap of hard-elastic material extending over at least a significant portion of a circumference of the flanges and having axial outer edges provided with teeth. The teeth are turned inwardly by more than 90° and have radially inwardly projecting ends. The teeth, when the connecting device is tightened about the flanges, are supported with prestress with their radially inwardly projecting ends on sides of the flanges facing away from one another and load the sealing device axially.

### BACKGROUND OF THE INVENTION

1. Field of the Invention

The invention relates to a device for axially connecting two pipe-like components, wherein radial flanges provided on end portions of the components can be loaded in a direction toward one another by a tightenable connecting device engaging the flanges positive-lockingly, and wherein a thermally highly loadable sealing device is arranged between the flanges.

2. Description of the Related Art

Presently, in the automobile industry a flange connection is used in the exhaust gas manifold for connecting pipe-like housing components each comprising an exchangeable soot filter (also called “particulate filter”) and a catalyst. The flange connection has radial flanges which are welded to the housing components and are connected to one another by several screws penetrating the flanges. Between the flanges a thermally highly loadable flat metal seal is clamped through which the screws are also guided. In order to be able to guide the screws through corresponding holes in the flanges, the outer diameter of the flanges must be significantly greater than that of the housing components. This requires a correspondingly large mounting space under the vehicle. Moreover, mounting and demounting of the numerous screws is time-consuming. All parts of the connecting device and of the housing can be exposed during operation to high temperatures of 500 to 900° C. and also to vibrations. Therefore, it must be ensured that the screw connection will not become detached and/or will lose its sealing action as a result of the thermal length change of the parts and of the vibrations. Moreover, it is desired to mount temperature and pressure sensors so as to extend through the connecting location of the housing parts; however, this is not possible in this flange connection because of lack of space.

In so-called coned flange connections, as disclosed, for example, in the German patent documents 30 38 491, 32 46 136 or 40 28 449, the connecting device has a so-called profiled-clamp with a clamping strap surrounding it which is tightened by a screw connection. The profiled clamp has inwardly curved conically diverging walls which, when tightening the clamp, contact corresponding conical sides of the flanges and pull the flanges against one another or against a seal arranged therebetween. The flanges are connected to the pipe-like components to be connected, such as pipes or round. housing parts, by welding or a frictional connection or are formed as unitary parts therewith. Such connecting devices require also a large mounting space because of their relatively great outer diameters. The configuration of the conical parts or surfaces is complex because they must have a conicity matching one another as closely as possible in order to be able to interact over large surface areas. In order to prevent the risk of a permanent deformation of the conical parts in connection with high inner pressure in the pipe-like components to be connected, they must have a high strength, and this increases the material expenditure.

Moreover, so-called claw couplings for connecting pipes with smooth end sections are known, for example, from German patent-documents 36 32 127 and 39 26 626. These claw couplings themselves, however, do not exert an axially acting-clamping force.

### SUMMARY OF THE INVENTION

It is an object of the present invention to provide a device of the aforementioned kind which is particularly suitable for use in the exhaust gas cleaning devices in the automobile industry, ensures a permanent, space-saving connection, withstands high forces, is easy to mount and demount, and makes possible the mounting of measuring sensors.

In accordance with the present invention, this is achieved in that the connecting device comprises at least one sheet metal strap of hard-elastic material extending over at least a significant portion of the circumference of the flanges and having teeth at its axial outer edges turned inwardly by more than 90° which, in the clamped state of the connecting device, are supported with prestress by means of their radially inwardly projecting ends on sides of the flanges facing away from one another and load the sealing device axially.

In this solution, the teeth of the sheet metal strap or straps are bent still farther against their spring force upon clamping of the connecting device. In this connection, the ends positioned at the flanges have the tendency to move in the axial direction toward the flanges. The flanges are therefore pressed more tightly against the sealing device positioned therebetween. The elasticity of the sheet metal strap material ensures that the teeth, upon releasing the connection, regain their original shape without being permanently deformed. Moreover, the teeth can compensate thermal diameter changes and can compensate vibrations or oscillations to a certain degree. The teeth can be very short and, accordingly, the flanges can be provided with a minimal outer diameter so as to be space-saving.

An especially suitable material for the sheet metal strap or straps is heat-resistant and corrosion-resistant steel. This material is at the same time substantially shock-resistant.

Moreover, it can be ensured that the sheet metal strap or straps in the area of the axial outer edges are surrounded by a tightenable clamp. The tightenable clamp can be a commercially available clamp, for example, a high-performance worm-driven clamp. Clamps have generally only one clamping element, for example, a clamping screw, which is pre-mounted and simplifies the mounting and demounting or connecting and separating of the pipe-like components.

Moreover, it is beneficial when the flanges are formed as unitary parts of metal strips extending in the circumferential direction of the end portions of the pipe-like components, wherein the metal strips are fixedly connected with the end portions. This configuration makes possible a simple connection of the flanges with the pipe-like components, preferably by welding.

Moreover, it can be ensured that the flanges have a spacing from the facing edges of the metal strips and that the sealing device has a metal sleeve with radially outwardly extending and adjoining, axially angled edge portions, wherein between the free edges of the axially angled edge portions and the facing sides of the flanges a paste containing metal particles is arranged, wherein the radial edge portions are located between the facing pipe-like components to be connected and in the vicinity of one of the two ends of the pipe-like components to be connected, respectively, and wherein the axial edge portions rest against one of the metal strips, respectively.

The metal sleeve in this way forms the main component of the sealing device. The metal sleeve itself must not be elastic and can withstand safely very high temperatures, as they are present, for example, in exhaust gas manifolds, in particular, in soot filters and catalysts mounted therein. The radially extending and adjoining axially angled edge portions of the sleeve not only effect positional securing of the sleeve between the pipe-like components, be it in the radial or axial direction, but also that of the pipe-like components. The paste which contains the metal particles, for example, a copper paste, serves for sealing the butt joints between the edges of the axial edge portions and the flanges and also withstands very high temperatures of much more than 500° C. The paste does not provide a fixed connection. Demounting of the connection is therefore easily possible in order to be able to exchange, for example, components such as filters and catalysts, inserted into the pipe-like components.

The sleeve can also be of a sufficient width as the sheet metal straps in order to provide them with holes for guiding through and mounting measuring sensors.

When the inner diameter of the metal sleeve between its radial edge portions is smaller than the pipe-like components to be connected, the radial edge portions of the sleeve can serve at the same time for positional securing of the components inserted into the pipe parts.

### BRIEF DESCRIPTION OF THE DRAWING

In the drawing:

FIG. 1 shows an axial section of one embodiment of an axial connector with connecting device according-to the invention between end portions of pipe-shaped components to be connected;

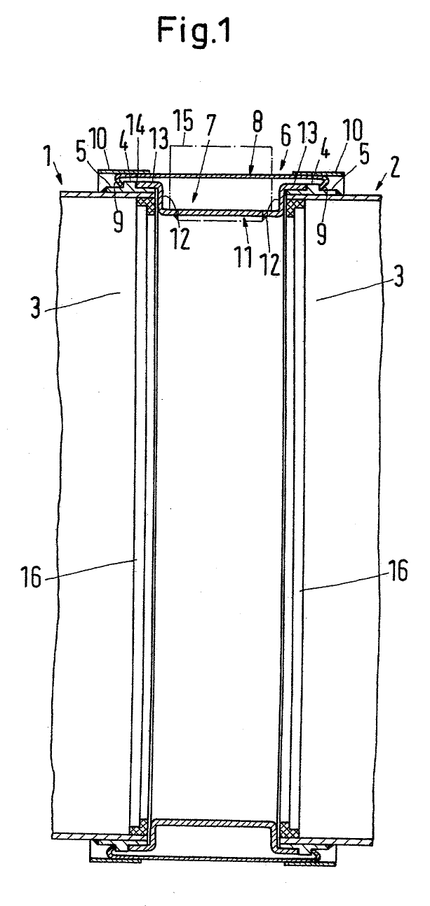

FIG. 2 shows an enlarged detail of FIG. 1; and

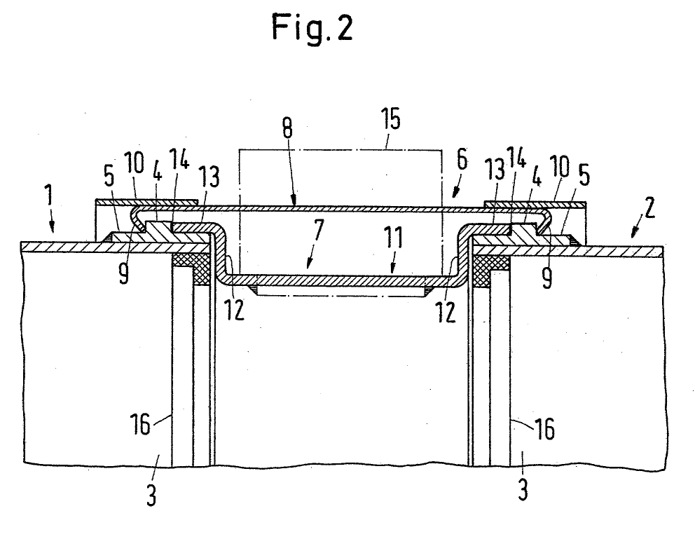

FIG. 3 shows a side view of sheet metal straps and a clamp surrounding it of a connecting device of the axial connector according to FIGS. 1 and 2.

### DESCRIPTION OF THE PREFERRED EMBODIMENTS

The axial connector illustrated as an example in the drawings serves for axially connecting two pipe-shaped components 1 and 2, in this case, housing parts of an exhaust gas manifold of a motor vehicle. In the pipe-shaped component 1 a soot filter (not illustrated, also referred to as “particulate filter”) is inserted and in the pipe-shaped component 2 a catalyst (not illustrated) is inserted. Each end portion 3 of the components 1 and 2 is surrounded by a radial flange 4 which is formed as a unitary part of a metal strip 5 fastened on the end portion 3, in this case, by welding. The flanges 4 can be loaded in a direction toward one another by a tightenable connecting device 6 which can engage the flanges 4 positive-lockingly, and a thermally highly loadable sealing device 7 is arranged between the flanges 4.

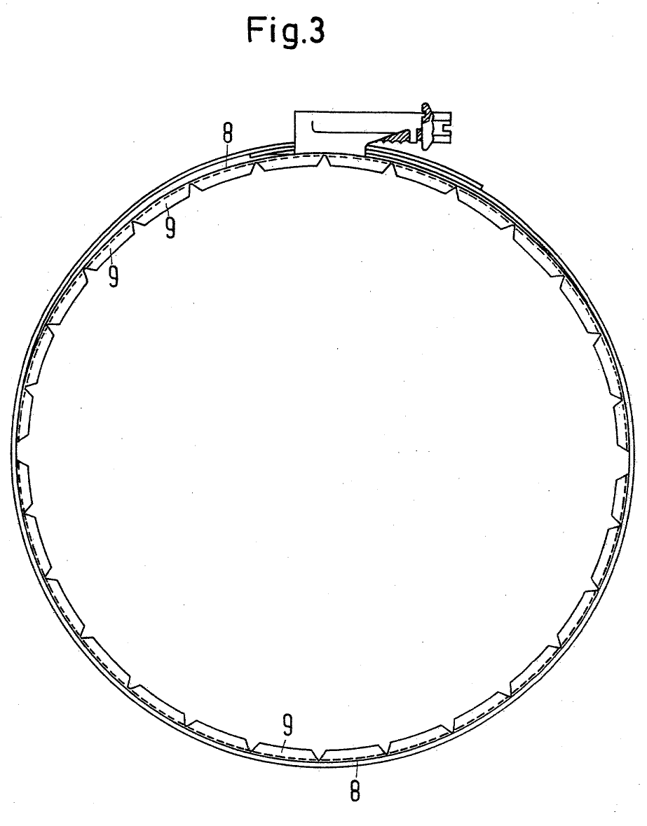

The connecting device 6 has at least one sheet metal strap 8 of hard-elastic material extending at least about a significant portion of the circumference of the flange 4 and having at its axial outer edges teeth 9 which are bent inwardly by more than 90° and define an angle of approximately 30° to 60°, here approximately 40° to 50°, preferably 45°, with the center part of the corresponding sheet metal strap 8. In the illustrated embodiment, see also FIG. 3, two such sheet metal straps 8 extending about approximately half the circumference of the flanges 4 are provided. However, it is also possible to provide only a single sheet metal strap 8 which extends almost over the entire circumference of the flange 4. In the tightened state of the connecting device 6, the teeth 9 are supported with their radially inner edges with prestress on the sides of the flanges 4 facing away from one another so that the sealing device 7 is axially loaded.

The, or each, sheet metal strap 8 is surrounded in the areas of the axial outer edges by a clamp 10, for example, a worm-driven clamp, as illustrated in FIG. 3, or by a clamp with a toggle catch.

The flanges 4 have a spacing from the facing edges of the two metal strips 5. The sealing device 7 is comprised substantially of a metal sleeve 11 with radially outwardly extending and axially angled end portions 12, 13. Between the free edges of the axial edge portions 13 and the facing sides of the flanges 4 a paste 14 containing metal particles is provided, preferably a so-called copper paste. The radially extending edge portions 12 are positioned between the facing ends of the pipe-shaped components 1, 2 to be connected and in proximity of one of the two ends, while the adjoining axial edge portions 13 rest on a metal-strip 5, respectively. The inner diameter of the metal sleeve 11 between its radial edge portions 12 is smaller than the inner diameter of the pipe-like components 1, 2 to be connected.

A measuring sensor 15 illustrated in dashed lines is guided through holes in the sheet metal strap 8 and in the metal sleeve 11 and is welded to the inner side of the metal sleeve 11. The measuring sensor 15 serves for measuring the temperature of the exhaust gas flowing through the metal sleeve 11. A further measuring sensor, not illustrated, can be mounted in the same way in the connecting device for measuring the gas pressure.

In the end portions 3 at the end of the pipe-like components 1 and 2 annular securing rings 16 stepped at the inside are inserted which surround the ends of the soot filter and of the catalyst at a radial spacing from the pipe-like components 1 and 2, respectively, in this case the housing parts, and support them radially and axially.

In the illustrated embodiment of the connecting device, the teeth 9, bent from the sheet metal strap or sheet metal straps 8, are further elastically bent upon tightening of the clamps 10. In this connection, the ends which rests against the flanges 4 have the tendency to move in the axial direction toward the flanges 4. The flanges 4 are thereby pressed more tightly against the sealing device 7 provided therebetween. The elasticity of the sheet metal straps 8 ensures that the teeth 9 upon releasing the connection will regain their original shape without being deformed permanently. Moreover, the teeth 9 can compensate thermal diameter changes of the pipe-like components 2 and sheet metal straps 8 and can also dampen vibrations or oscillations to some degree. The teeth 9 are radially very short so that the flanges 4 can be produced with minimal outer diameter in a space-saving way. The sheet metal straps 8 can be produced of steel which is not only hard-elastic but at the same time shock-resistant, heat-resistant and corrosion-resistant. Particularly suitable are steel qualities of the designation 1.4509; 1.4510; 1.4522 according to European norm EN 10088 (US norm AISI Ti; AISI 309) and 1.4828 (Stahl Eisen Werkstoff-Blatt (Steel Iron Material Data Sheet); AISI 309) as well as spring steel. Also, the sleeve 11 can be comprised of one of the aforementioned steels. Preferably, it is comprised of the material No. 1.4509 or 1.4510.

The use of clamps 10 is advantageous because, in general, they have only one clamping element, for example, a clamping screw or a clamping lever, which is pre-mounted and simplifies mounting and demounting as well as connecting and separating of the pipe-like components 1, 2 for installing and removing as well as exchanging the filters and catalyst.

The sheet metal straps 8 and sleeve 11 can be of such a width that sufficient space for mounting of the measuring sensor 15 and a further measuring sensor, arranged in a staggered position in the circumferential direction relative to the measuring sensor 15, is provided.

The angled arrangement of the edge portions 12 and 13 in connection with the reduced inner diameter of the sleeve 11 in comparison to that of the components 1, 2 has the advantage that, on the one hand, the radial and axial position of the sealing device 7 and, on the other hand, that of the components 1, 2 is secured and that the metal sleeve 11 provides an abutment for the axial forces of the teeth 9 during tightening of the clamp 10. At the same time, the metal sleeve 11 provides, via the securing rings 16, an abutment for the soot filter or catalyst mounted within the housing parts 1, 2 in order to secure the axial position of the soot filter and catalyst.

The metal sleeve 11 is also thermally highly loadable as is the metal-containing paste 14. It withstands temperatures of at least approximately 500° C. However, the sealing device 7, upon detachment of the connecting device 6, can be easily removed because the paste 14 provides no fixed connection. After cleaning the sealing surfaces of the flange 4 and the edges of the metal sleeve 11 that come into contact with the paste 14, the metal sleeve 11, after renewing the application of the metal-containing paste 14, can again be mounted.

Overall, the connecting device only requires a minimal mounting space in the radial direction past the outer diameter of the pipe-like components 1, 2 to be connected because the teeth 9 and the flanges 4 are relatively short in the radial direction.

While specific embodiments of the invention have been shown and described in detail to illustrate the inventive principles, it will be understood that the invention may be embodied otherwise without departing from such principles.

What is claimed is:

1. An axial connector for axially connecting two pipe-shaped components, wherein the two pipe-shaped components have end portions with radial flanges, wherein the device comprises:
a tightenable connecting device engaging the two flanges positive-lockingly and loading the two flanges in a direction toward one another;
a thermally highly loadable sealing device arranged between the flanges;
wherein the connecting device comprises at least one sheet metal strap of hard-elastic material extending over at least a significant portion of a circumference of the flanges and having axial outer edges provided with teeth;
wherein the teeth are turned inwardly by more than 90° and have radially inwardly projecting ends;
wherein the teeth, when the connecting device is tightened about the flanges, are supported with prestress with the radially inwardly projecting ends on sides of the flanges facing away from one another and load the sealing device axially.

2. The axial connector according to claim 1, wherein the at least one sheet metal strap is comprised of heat-resistant and corrosion-resistant steel.

3. The axial connector according to claim 1, wherein the connecting device comprises at least one tightenable clamp surrounding the at least one sheet metal strap in the area of the axial outer edges.

4. The axial connector according to claim 1, wherein the flanges are unitary parts of metal strips extending circumferentially about the end portions of the pipe-shaped components and fixedly connected to the end portions.

5. The axial connector according to claim 4, wherein the metal strips are welded onto the end portions.

6. The axial connector according to claim 4, wherein the flanges are spaced from facing edges of the metal strips, wherein the sealing device comprises a metal sleeve having radially outwardly extending edge portions adjoined by axially angled edge portions, wherein the sealing device further comprises a paste containing metal particles and wherein the paste is arranged between free edges of the axially angled edge portions and sides of the flanges facing the free edges of the axially angled edge portions, wherein the radially outwardly extending edge portions are located between the facing pipe-shaped components to be connected and in the vicinity of one of the two end portions of the pipe-shaped components to be connected, respectively, and wherein the axially angled edge portions rest against one of the metal strips, respectively.
